(19) United States
(12) Patent Application Publication
(10) Pub. No.: US 2015/0308324 A1
(43) Pub. Date: Oct. 29, 2015

(54) Housing and method for producing the housing

(71) Applicant: CONTINENTAL AUTOMOTIVE GMBH, Hannover (DE)

(72) Inventors: Thomas HANNEWALD, Grieshelm (DE); Joachim KÜCH, Cornberg (DE)

(21) Appl. No.: 14/651,599

(22) PCT Filed: Dec. 10, 2013
(86) PCT No.: PCT/EP2013/076092

§ 371 Date: Jun. 11, 2015

(30) Foreign Application Priority Data
Dec. 14, 2012 (DE) 10 2012 223 156.0

(51) Int. Cl. F01P 3/14; B23P 15/26

(52) U.S. Cl. CPC F01P 3/14; B23P 15/26

(57) ABSTRACT

A housing includes: a channel in which a flap is rotatably arranged on a shaft, and at least one heating or cooling channel. The heating or cooling channel is a tube made of a highly heat-conducting material and is enclosed by the housing, changes in the direction of the heating or cooling channel being continuous.

### CROSS-REFERENCE TO RELATED APPLICATIONS

This is a U.S. national stage of application No. PCT/EP2013/076092, filed on 10 Dec. 2013, which claims priority to the German Application No. DE 10 2012 223 156.0 filed 14 Dec. 2012, the content of both incorporated herein by reference.

### BACKGROUND OF THE INVENTION

1. Field of the Invention

The invention relates to a housing having a channel in which a valve member is rotatably arranged on a shaft. The invention further relates to a method for producing such a housing.

2. Related Art

Such housings are used as throttle valve connection pieces or for air and exhaust gas valves in motor vehicles. These housings, which comprise cast aluminum, are thermally loaded as a result of the flowing medium. Throttle valve connection pieces are thus heated in order to prevent the formation of ice, while the housings of air and exhaust gas valves have to be cooled as a result of the high temperatures of use. Water is used for cooling and is guided through one or more channels in the housing. In order to produce the channels, the channels are formed in the cast housing by mechanical processing, for example, drilling. For connection to the water supply, connection pipes are screwed or pressed onto the channel ends. For secure sealing, the connection pipes are additionally sealed or adhesively-bonded. It is disadvantageous that the channel can extend only in the regions in which it can be produced by mechanical processing. This means that the channel does not always have an optimal path that corresponds to the function thereof and consequently the housing cannot be optimally heated or cooled. Furthermore, in the case of a non-linear path, the channel can always be composed of only linear portions, the number of portions to be introduced being limited as a result of the complexity of processing. This also results in the channel not being optimally adapted to the function thereof. In addition, the mechanical introduction of the channel brings about a series of processing openings, which have to additionally be closed and sealed. Finally, the channels produced in this manner often have abrupt direction changes, which lead to occurrences of turbulence and consequently to power losses.

Furthermore, in channels which are produced by mechanical processing, pores and cavities, which are contained in the cast housing, can be connected to the channel, which may sometimes lead to sealing problems.

### SUMMARY OF THE INVENTION

An object of the invention is therefore to provide a housing in which the heating or cooling channel can be produced in a simpler manner and which can be connected to the water supply in a simpler manner. Another object is to provide a method for producing such a housing.

The first object is achieved with a housing in which the heating or cooling channel is a pipe of a highly thermally-conductive material, direction changes of the heating or cooling channel have a consistent path and the heating or cooling channel is surrounded by the housing.

With the separate pipe, in the case of a housing which can be produced by casting, the pipe can be integrated in the housing during the casting operation. In this manner, the heating or cooling channel is produced. The subsequent mechanical formation of the heating or cooling channel can thereby be dispensed with, which formation requires substantially more complexity. The seals of the processing holes can consequently also be dispensed with.

Overall, the housing comprises fewer components and is consequently more cost-effective. With the construction of the heating or cooling channel as a separate pipe, the heating or cooling channel can now be formed in advance and can consequently be adapted in a significantly better manner to its function in terms of the path thereof. In particular, the heating or cooling channel according to invention can extend in regions which are not accessible to channels produced by mechanical processing. In addition, with direction changes, the flow in the heating or cooling channel is redirected with a radius and consequently consistently, i.e., so as to be uniformly continuous, whereby occurrences of turbulence are minimized.

In an advantageous embodiment, the pipe of the heating or cooling channel comprises aluminum or copper. These materials ensure, as a result of their good heat conductivity, effective heating or cooling, whereby a smaller channel cross-section or a small heating or cooling medium quantity can be used.

A simpler assembly is achieved when the ends of the heating or cooling channel are constructed to connect a line.

The second object is achieved according to an aspect of the invention in that a pipe is brought into the shape of the heating or cooling channel that extends in the housing, in that the heating or cooling channel is subsequently placed in the manner of a core into a casting mould for the housing and is subsequently cast-in when the housing is cast.

The housings produced with this method can be constructed with heating or cooling channels having a bent path. In addition to the advantage of placing the channels in the regions in which they may have their greatest effect, the radii result in fewer occurrences of turbulence being produced in the flow path.

According to an advantageous embodiment, the pipe is filled with an incompressible and heat-resistant medium before it is brought into the shape of the heating or cooling channel which extends in the housing. In this manner, it is ensured that, when the pipe is shaped, only the path thereof but not the cross-section of the pipe is changed.

According to another embodiment, the housing can be produced in a cost-effective manner when the at least one pipe for the at least one heating or cooling channel is brought into such a shape that the pipe ends thereof have an orientation which is adapted to the casting mould for the housing since, in this manner, the casting mould can be produced in a simpler and therefore more cost-effective manner.

If the pipe ends in the installed state have to have a different orientation, the pipe ends, after the casting of the housing, are bent into the position in which they are connected to the connection lines.

In order to ensure a sealed and durably stable connection of the pipe ends to the connection lines, the geometry of the pipe ends has to have a high level of precision. In order to prevent damage to the pipe ends during the casting operation, in another embodiment the pipe ends are shaped to form the connection of a line, respectively, after the casting of the housing.

### BRIEF DESCRIPTION OF THE DRAWINGS

The invention is described in greater detail with reference to an embodiment. In the drawings:

FIG. 1 shows the housing of an exhaust gas valve according to the prior art; and

FIG. 2 shows a housing according to an embodiment of the present invention.

### DETAILED DESCRIPTION OF THE PRESENTLY PREFERRED EMBODIMENTS

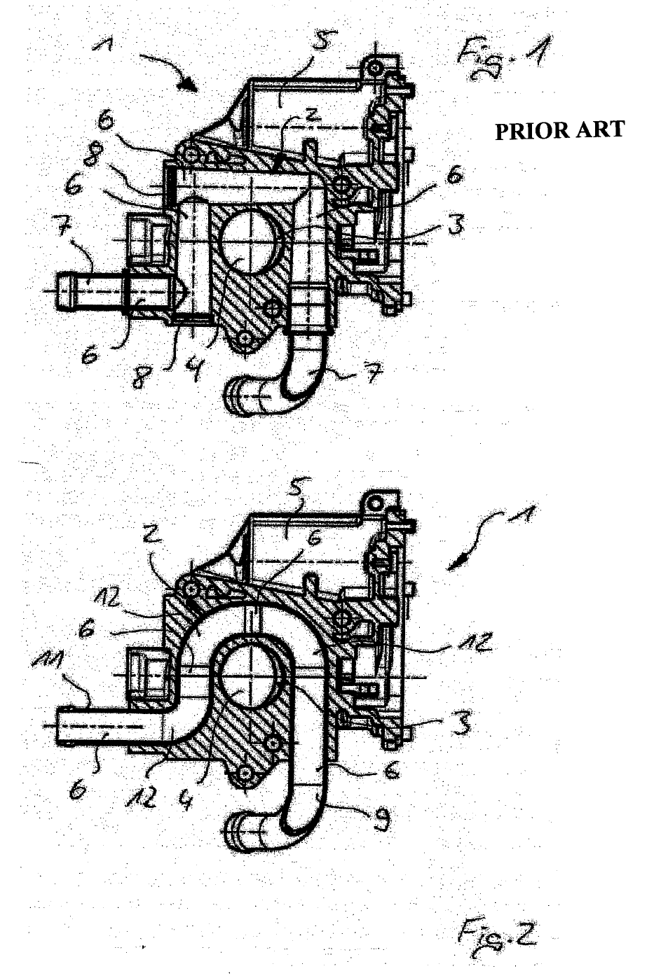

FIG. 1 shows a housing 1 of an exhaust gas valve, which is cut in the region of the cooling channel 2. The housing 1 comprises aluminum diecasting and has a channel 3 through which the exhaust gas flows. In this channel 3, a valve member 4 is rotatably supported on a shaft which cannot be seen. The shaft is driven, by a gear not illustrated, by an electric motor arranged in a chamber 5 of the housing 1. As a result of the hot exhaust gas, the housing 1 has to be cooled in the region of the valve member 4. The cooling channel 2 comprises four linear portions 6 which are drilled in the housing 1, two adjacent portions being in abutment with each other at right-angles, respectively. This inconsistent path of the direction changes produces occurrences of turbulence in the flow path. In the portions 6 that form the inlet and outlet, there are inserted pipe connection pieces 7 to which the lines of the cooling medium circuit are connected. The other two portions 6 in the center region are closed with sealing stoppers 8 at the ends thereof which do not belong to the cooling channel 2. As a result of the portions 6, which are arranged at right-angles with respect to each other, the channel 3 is surrounded by the cooling channel 2 with non-uniform spacings.

The housing 1 of the exhaust gas valve in FIG. 2 has the same construction with the exception of the cooling channel 2. The cooling channel 2 comprises an aluminum pipe 9, which has previously been filled with a salt. Subsequently, the pipe 9 is bent into the path illustrated with the exception of the end 10, with two linear portions 6 being connected with a radius 12. As a result of this consistent path, on the one hand, occurrences of turbulence are minimized and, on the other hand, the cooling channel 2 is guided with almost constant spacing around the channel 3 for the exhaust gas, whereby a significantly more homogeneous cooling is possible and the thermal loads of the housing are minimized. The end 10 was originally also in the plane of section. In this embodiment, the pipe 9 can be placed more readily in the casting mold for the housing 1. After the casting of the housing 1 in which the pipe 9 was cast in the housing 1, the end 10 is bent into the orientation shown and the connection contours for connection to the connection lines are produced at both ends 10, 11. With the removal of the salt from the pipe 9, the cooling channel 2 is complete.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A housing comprising:
at least one heating or cooling channel (2), wherein:
the heating or cooling channel (2) is a pipe (9) of a highly thermally-conductive material, the pipe having direction changes having a uniformly continuous consistent path, the pipe being surrounded by the housing (1).

10. The housing as claimed in claim 9, wherein the pipe (9) comprises aluminum or copper.

11. The housing as claimed in claim 9, wherein the pipe (9) has ends (10, 11), the ends (10, 11) being configured to connect to a line.

12. A method for producing a housing having a heating or cooling channel that extends within the housing, the method comprising:
bringing a pipe into the shape of the heating or cooling channel that extends in the housing;
subsequently placing the heating or cooling channel, in the manner of a core, into a casting mold for the housing; and
subsequently casting the housing around the pipe.

13. The method as claimed in claim 12, further comprising filling the pipe with an incompressible and heat-resistant medium before bringing the pipe into the shape of the heating or cooling channel that extends in the housing.

14. The method as claimed in claim 13, further comprising bringing the pipe for the heating or cooling channel into a shape such that pipe ends thereof have an orientation adapted to a casting mold for the housing.

15. The method as claimed in claim 14, wherein the pipe has ends, the method further comprising bending the pipe ends, after the casting of the housing, into a position in which the respective pipe ends are connectable to connection lines.

16. The method as claimed in claim 14, further comprising shaping the pipe ends to form a connection of a line, respectively, after the casting of the housing.
